(19) United States
(12) Patent Application Publication
(10) Pub. No.: US 2010/0195490 A1
(43) Pub. Date: Aug. 5, 2010

(54) AUDIO PACKET RECEIVER, AUDIO PACKET RECEIVING METHOD AND PROGRAM

(76) Inventors: Tatsuya Nakazawa, Tokyo (JP); Kazunori Ozawa, Tokyo (JP)

Correspondence Address: Mr. Jackson Chen, 6535 N. STATE HWY 161, IRVING, TX, 75039, US

(21) Appl. No.: 12/602,547

(22) PCT Filed: May 22, 2008
(86) PCT No.: PCT/JP2008/059444

§ 371 Date: Dec. 1, 2009

(30) Foreign Application Priority Data
Jul. 9, 2007 (JP) 2007-179450

(51) Int. Cl. H04J 1/16

(52) U.S. Cl. 370/216; 370/242

(57) ABSTRACT

The audio packet receiver according to the present invention includes a buffer unit (101) for extracting audio coded data from an audio packet and storing the extracted audio coded data into a buffer, and also for detecting the packet loss; a distance calculating unit (102) for calculating the distance between a location in the buffer unit (101) where the packet loss is detected and a location where the next audio coded data is stored; a controlling unit (103) for determining a gain value of the audio data for the concealed audio based on the distance calculated at the distance calculating unit (102); and a decoding unit (104) for performing audio error concealment based on the gain value of the audio data for the concealed audio that is determined by the controlling unit (103).

### TECHNICAL FIELD

The present invention relates to audio error concealment in which audio data for concealed audio is generated in an audio packet receiver when packet loss is detected.

### BACKGROUND ART

As a kind of packet communication for communicating packetized audio data, VoIP (voice over IP) has been widely used. In VoIP communication, coded audio data is packetized into RTP (Real-time Transport Protocol) packets (Non Patent Document 1).

In addition to audio, distribution services of streams of multiple media including videos, texts, tiles and the like as well as interactive communication services thereof have also been deployed.

A packet communication network, however, may have packet loss; an event in which packets are lost (or have disappeared).

Such an event inevitably degrades the audible quality of such a medium as audio at an audio packet receiver that receives audio packets.

Therefore, some measures for alleviating such packet-loss-induced degradation of audio quality at an audio packet receiver have been proposed.

Patent Document 1, for example, discloses a method for preventing degradation of audio quality by generating audio data for concealed audio by using audio error concealment when packet loss is detected. In document 1, as audio error concealment, a packet immediately before or after the lost audio packet is duplicated.

As an example of an audio coding method used on the side of an audio packet transmitter, a method for generating an audio coded stream with coding efficiencies that vary based on the determination of the presence of audio has been known.

As another example of an audio coding method used on the, side of an audio packet transmitter, a method for generating an audio coded stream periodically or each time when information on ambient background noise (hereinafter, the information on background noise is referred to as noise) is updated has also been known.

As yet another example of an audio coding method used on the side of an audio packet transmitter, a method is disclosed in Non-Patent Document 2 for packetizing only an audio coded stream that is generated when audio is present or when noise occurs and sending out the audio packet to a packet communication network and not sending out the audio packet when no audio is present based on the determination of the presence of audio has also been known.

The technique disclosed in Patent Document 1, however, has the problems that are described below.

The first problem is that the technique may not sufficiently recover degraded audio quality even if audio packets are duplicated on the audio packet receiver side before and after the location where packet loss is detected, because time axially continuous audio packets are not necessarily sent out in a periodic manner depending on the audio coding method, and even on transmission specifications that are used on the audio packet transmitter side.

The second problem is that audio error concealment is carried out based on a predetermined gain value or a predetermined attenuation factor regardless of the presence of audio data that comes after (i.e. in future on the time axis) the audio data for the concealed audio. Therefore, excessive or too little attenuation will not adequately alleviate audible degradation of audio quality.
[Patent Document 1] Japanese Unexamined Patent Application Publication No. 2005-157045
[Non Patent Document 1] Schulzrinne, H., Casner, S., Frederick, R., Jacobson, V.m “RTP: A Transport Protocol for Real-Time Applications”, RFC3550, July 2003, [searched on June, 27th, Heisei 19 (2007)] Internet <URL: http://www.ietf.org/rfc/rfc3550.txt>
[Non Patent Document 2] Sjoberg, J., Westerlund, M., Lakaniemi, A., Xie, Q., V.m “Real-Time Transport Protocol (RTP) Payload Format and File Storage Format for the Adaptive Multi-Rate (AMR) and Adaptive Multi-Rate Wideband (AMR-WB) Audio Codec”, RFC3267, June 2002, [searched on June, 27th, Heisei 19 (2007)] Internet <URL: http://www.ietf.org/rfc/rfc3267.txt>

### DISCLOSURE OF THE INVENTION

An object of the present invention is to provide an audio packet receiver, an audio packet receiving method and a program for the same which can alleviate the abovementioned problems of degradation of audio quality in audio error concealment.

In order to achieve the abovementioned object, the audio packet receiver according to the present invention is

an audio packet receiver that performs audio error concealment for generating audio data for concealed audio when packet loss is detected, characterized by comprising:

a buffer unit that extracts audio coded data from an audio packet and stores the extracted audio coded data into a buffer, and that also detects the packet loss;

a distance calculating unit that calculates a distance between a location in said buffer where the packet loss is detected and a location where a next audio coded data is stored;

a controlling unit that determines a gain value of the audio data for the concealed audio based on the distance calculated at said distance calculating unit; and

a decoding unit that performs audio error concealment based on the gain value of the audio data for the concealed audio that is determined by said controlling unit.

In order to achieve the abovementioned object, the audio packet receiving method according to the present invention is

an audio packet receiving method performed by an audio packet receiver that performs audio error concealment for generating audio data for concealed audio when packet loss is detected, characterized by comprising:

detecting packet loss by extracting audio coded data from an audio packet and storing the extracted audio coded data into a buffer, and then detecting the packet loss;

calculating a distance between a location in said buffer where the packet loss is detected and a location where a next audio coded data is stored;

determining a gain value of the audio data for the concealed audio based on said calculated distance; and

performing the audio error concealment based on said determined gain value of the audio data for the concealed audio.

In order to achieve the abovementioned object, the program according to the present invention is characterized by causing a computer, that performs audio error concealment for generating audio data for concealed audio when packet loss is detected, to execute:

detecting packet loss by extracting audio coded data from an audio packet and storing the extracted audio coded data into a buffer, and then detecting the packet loss;

calculating a distance between a location in said buffer where the packet loss is detected and a location where a next audio coded data is stored;

determining a gain value of the audio data for the concealed audio based on said calculated distance; and
performing the audio error concealment based on said determined gain value of the audio data for the concealed audio.

The present invention adjusts the gain value of the audio data for the concealed audio that is generated in audio error concealment when packet loss is detected, according to the distance between a location in the buffer where the packet loss is detected and a location where the next audio coded data is stored.

Specifically, the present invention can prevent an excessive or too little gain value from being set, as it performs the audio error concealment by taking account of the distance up to the audio data that comes after (i.e. in future on the time axis) the audio data for the concealed audio.

Thus, the present invention has an advantage of alleviating degradation of audio quality to human ears without being affected by any transmitting operation of the audio packet transmitter.

### BRIEF DESCRIPTION OF THE DRAWINGS

FIG. 1 is a block diagram showing a configuration of an audio packet receiver according to a first exemplary embodiment of the present invention;

FIG. 2 is a diagram for illustrating an advantage of the first exemplary embodiment of the present invention;

FIG. 3 is a block diagram showing a configuration of an audio packet receiver according to a second exemplary embodiment of the present invention; and

FIG. 4 is a block diagram showing a configuration of an audio packet receiver according to a third exemplary embodiment of the present invention.

### BEST MODE FOR CARRYING OUT THE INVENTION

The best modes for carrying out the present invention will be described below with reference to the drawings.

### First Exemplary Embodiment

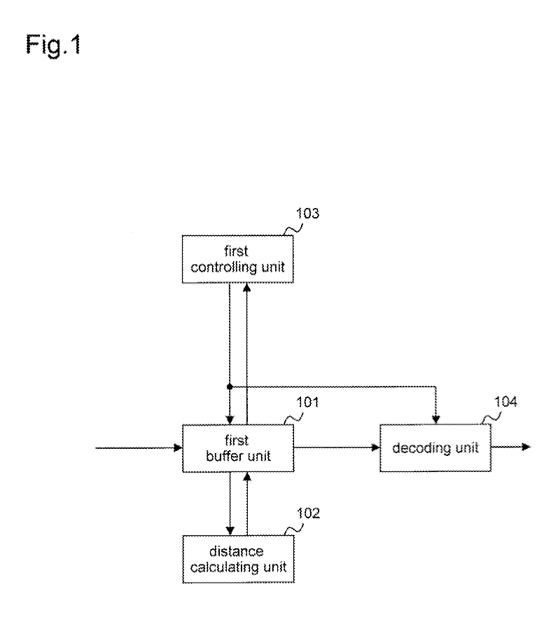

As shown in FIG. 1, the audio packet receiver of the exemplary embodiment includes: first buffer unit 101 for extracting audio coded data from an audio packet, which is an RTP packet, and storing the extracted audio coded data into a buffer, and also for detecting packet loss; distance calculating unit 102 for calculating a distance between a location in the buffer where the packet loss is detected and a location where the next audio coded data is stored; first controlling unit 103 for determining a gain value of audio data for concealed audio that is generated in audio error concealment based on the distance calculated by distance calculating unit 102; and decoding unit 104 for decoding the audio coded data when no packet loss has been detected and performing audio error concealment based on the gain value of the audio data for the concealed audio that is determined by first controlling unit 103 when packet loss is detected in first buffer unit 101. Here, the gain value refers to a parameter regarding the sound volume of the finally generated audio data. An attenuation factor which is used below is also a kind of gain value.

In the exemplary embodiment, each of the abovementioned components specifically performs the operation below. It is assumed that the audio coding method for the audio packet is determined in advance through the interaction between the audio packet receiver and a counterpart audio packet transmitter. In the present invention, the method of interaction between an audio packet receiver and an audio packet transmitter is not particularly limited and such methods as those based on the SIP (Session Initiation Protocol), which is disclosed in Non Patent Document 3 (Handley, M., Schulzrinne, H., Schooler, E., Rosenberg, J., “SIP: Session Initiation Protocol”, RFC 2543, March 1999, [searched on June, 27th, Heisei 19 (2007)] Internet <URL: http://www.ietf.org/rfc/rfc2543.txt>, or the H.223, or otherwise the other unique methods may be used.

When first buffer unit 101 receives an audio packet, it separates the audio packet by the unit of an audio coded data according to the predetermined audio coding method. First buffer unit 101 stores the audio coded data into a buffer, according to at least one item of information from among the following: the RTP sequence number, the RTP time stamp value, the marker bit, and the RTP payload time value in the RTP header of the audio packet (hereinafter, they are collectively referred to as the RTP header information).

The RTP sequence number or the RTP time stamp value skips, as a result of the operation of the audio packet transmitter in which a packet is not transmitted when no sound is detected, packet loss in the packet communication network, or change in sequence due to fluctuation of the packet communication network. Here, it is assumed that first buffer unit 101 has a function of detecting packet loss according to the presence of the audio coded data at the location of the buffer head (whether the audio coded data is received or not) under the above mentioned circumstance.

When first buffer unit 101 receives an instruction to acquire packet loss occurrence information from first controlling unit 103, it outputs an instruction to calculate a distance between the location of the buffer head and the location of the next stored audio coded data to distance calculating unit 102. First buffer unit 101 checks the location of the buffer head. If the audio coded data is present at the head location, first buffer unit 101 judges that no packet loss occurs and outputs the packet loss occurrence information indicating that no packet loss has been detected to first controlling unit 103. If the audio coded data is not present at the head location, first buffer unit 101 judges that packet loss occurs, and outputs the packet loss occurrence information indicating that packet loss has been detected and distance information that can be acquired from distance calculating unit 102 to first controlling unit 103.

First buffer unit 101 may output the instruction to calculate to distance calculating unit 102 only when packet loss has been detected.

When packet loss has not been detected, first buffer unit 101 outputs the audio coded data at the location of the buffer head to decoding unit 104. When packet loss has been detected, it outputs the packet loss detecting information indicating as such to decoding unit 104.

When distance calculating unit 102 receives the instruction to calculate from first buffer unit 101, it calculates the distance between the location of the buffer head and the location of the next stored audio coded data, and outputs distance information indicating the calculated result to first buffer unit 101.

Here, the distance information refers to information indicating a difference value of the RTP time stamp value or a value equivalent to the difference value. Specifically, the distance information refers to information indicating the difference value between the RTP time stamp value at the location of the buffer head and the RTP time stamp value of the next stored audio coded data.

If the next stored audio coded data is not present, the distance information may be a value indicating that no audio coded data is present, for example, an extraordinary big value that is out of a range to be stored in the buffer.

In the case where a counterpart audio packet transmitter performs a non-intermittent transmitting operation for transmitting an audio packet regardless of the presence of audio, if information equivalent to the distance information that can be acquired from the difference value of the RTP time stamp value based on the difference value between the RTP sequence number at the location of the buffer head and the RTP sequence number of the next stored audio coded data, the difference value of the RTP sequence number may be used for the distance information.

First controlling unit 103 outputs an instruction to acquire the packet loss occurrence information to first buffer unit 101 on a predetermined cycle.

If first controlling unit 103 acquires the packet loss occurrence information indicating that packet loss has not been detected from first buffer unit 101, it outputs an instruction to decoding unit 104 to decode the audio coded data. If first controlling unit 103 acquires the packet loss occurrence information indicating that packet loss has been detected and acquires the distance information from first buffer unit 101, it determines the gain value of the audio data for the concealed audio that is generated in the audio error concealment based on the distance information, and outputs gain value information indicating the determined result and an instruction to decode to decoding unit 104.

Here, the gain value information is assumed to be in the range, for example, from 0 to 1. If the value is 1, it indicates that the audio coded data is to be decoded so that the gain value becomes equivalent to the audio data which is acquired at the previous decoding by decoding unit 104. If the value is 0, it indicates that the audio coded data is to be decoded with a predetermined gain value. If the value is a mean value between 0 and 1, it indicates that the audio coded data is to be decoded so that the gain value becomes that of the audio data, which is acquired at the previous decoding, multiplied with the mean value.

When first controlling unit 103 acquires the packet loss occurrence information indicating that packet loss has been detected and acquires the distance information from first buffer unit 101, it sets the gain value closer to 1 since the distance between the location of the buffer head and the location of the next stored audio coded data is shorter, and it sets the gain value closer to 0 since the distance is longer based on the distance information.

The abovementioned gain value information is merely an example. For example, the gain value information may be represented by its rate of change against the gain value set to decoding unit 104 in advance (to be described later) or the gain value information may be represented by a value equivalent to the rate of change, without any limitation.

From first buffer unit 101, either the audio coded data, that is present at the location of the butler head, or the packet loss detecting information is input into decoding unit 104. From first controlling unit 103, an instruction to decode is input into decoding unit 104. If packet loss has been detected, the gain value information is input from first controlling unit 103 into decoding unit 104 as well.

If the audio coded data is input from first buffer unit 101, decoding unit 104 decodes the audio coded data according to the predetermined audio coding method and outputs the decoded data. If the packet loss detecting information is input from first buffer unit 101, decoding unit 104 generates the audio data for the concealed audio by performing audio error concealment based on the gain value information that is input from first controlling unit 103 and outputs the generated audio data.

As mentioned above, in the exemplary embodiment, the gain value of the audio data for the concealed audio that is generated in audio error concealment is adjusted according to the distance between the location in the buffer where the packet loss is detected and a location where the next audio coded data is stored.

Specifically, the exemplary embodiment can prevent an excessive or too little gain value from being set, as it performs the audio error concealment by taking account of the distance up to the audio data that comes after (i.e. in future on the time axis) the audio data for the concealed audio.

Thus, the exemplary embodiment has an advantage of alleviating degradation of audio quality to human ears without being affected by any transmitting operation of the audio packet transmitter.

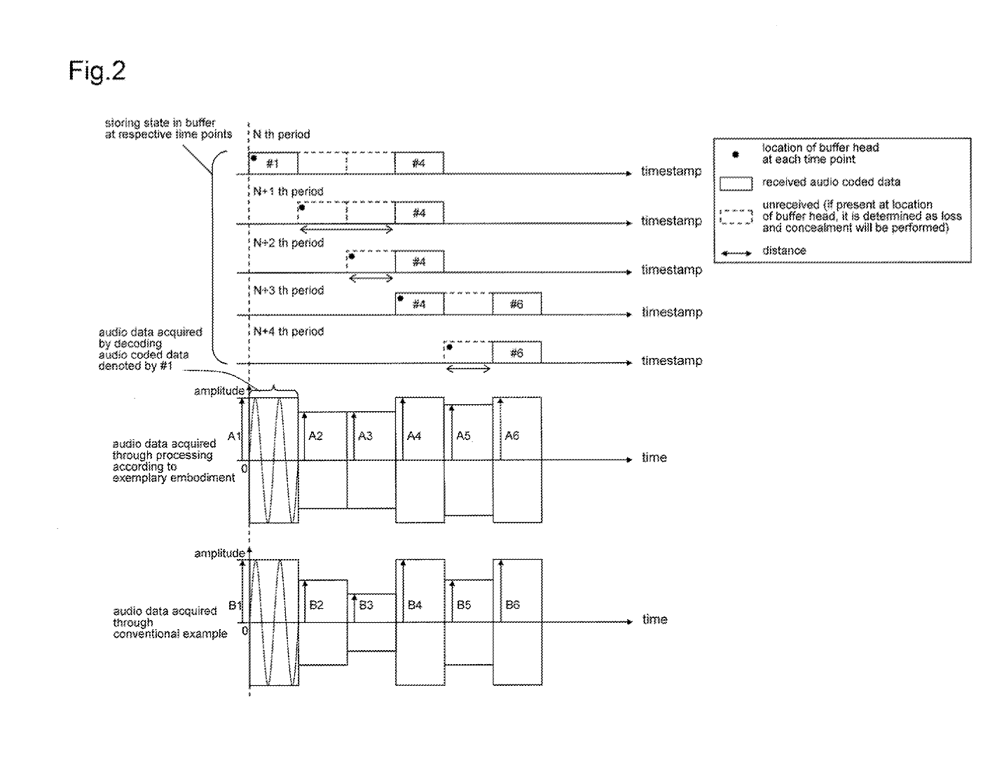

Now, an advantage of the exemplary embodiment will be described in further detail with reference to FIG. 2 by comparing the exemplary embodiment with the case where the states in the buffer are not taken into account (hereinafter, referred to as an object of comparison). Here, a method for gradually decreasing the gain value of the audio data for the concealed audio when serially performing audio error concealment is exemplified as an object of comparison.

The upper part of FIG. 2 exemplifies how the audio coded data is stored in the buffer in first buffer unit 101. In this example, it is assumed that the audio coded data is permutated and stored in the buffer according to the RTP time stamp value in the RTP header of the audio packet. In the example, the abscissa represent the time stamp values. In the example, it is assumed that the audio packets which store audio coded data #2, #3 and #5 are lost in the communication network they passed through. Here, the location of the buffer head at each time point is marked with the sign “•”.

The lower part of FIG. 2 shows respective examples of audio data that is acquired through a conventional example and through the exemplary embodiment right beneath the respective audio coded data. FIG. 2 shows some waveforms for the respective audio sample values, whose respective amplitude values are each connected with lines. For simplicity of drawing, only the first N^{th} audio data is accompanied with the waveform and each case of audio data thereafter is just accompanied with a frame (rectangle) which indicates a decoding unit with a waveform omitted. Also for simplicity of drawing and description, it is assumed that the same gain value (amplitude) will result from receiving and decoding audio coded data #1 to #6 respectively.

The object of comparison attenuates gain value G (B1) of audio coded data #1 and gain values G (B2) and G (B3) of the audio data for the concealed audio which substitute for audio coded data #2 and #3 such that the gain values are G (B1)>G (B2)>G (B3).

In contrast, the exemplary embodiment generates audio data A2 for the concealed audio that substitutes for audio coded data #2 in the manner below: First, it calculates the distance between the location of the head in the buffer at the time (N+1^{th} period) and the location where next audio coded data #4 is stored. Here, it judges that the locations are not so far apart from each other and generates audio data A2 by suppressing the attenuation of the gain value. Specifically, it generates audio data A2 such that the gain values result in G (A2)>G (B2).

Similarly, the exemplary embodiment generates audio data A3 for the concealed audio that substitutes for audio coded data #3 in the manner below: First, it calculates the distance between the location of the head in the buffer at the time (N+2^{th} period) and the location where next audio coded data #4 is stored. Here, as the next audio coded data #4 comes immediately after the location of the head in the buffer, the exemplary embodiment generates audio data A3 with the same gain value as that of audio data A3. Specifically, it generates audio data A3 such that the gain values result in G (A3)>G (B3). The exemplary embodiment also generates audio data A5 for the concealed audio that substitutes for audio coded data #5 in the same manner.

As mentioned above, the exemplary embodiment can suppress excessive attenuation of gain values G (A2) and G (A3) of audio data A2 and A3 by determining gain values G (A2) and G (A3) of audio data A2 and A3 for the concealed audio according to the distance from next audio data A4.

### Second Exemplary Embodiment

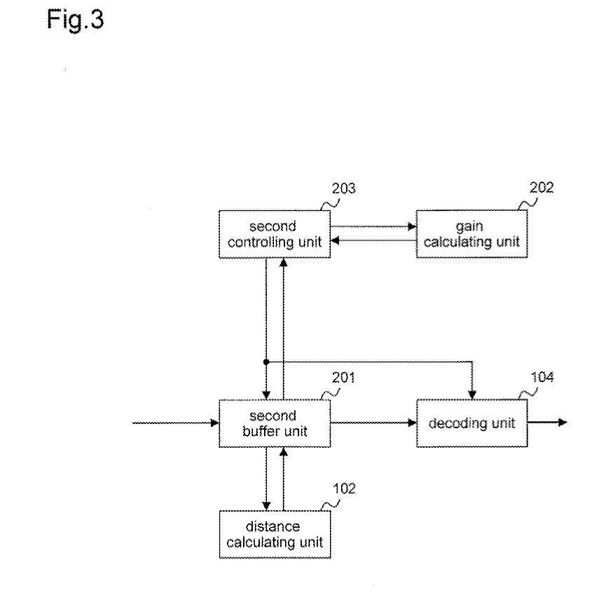

As shown in FIG. 3, the audio packet receiver of the exemplary embodiment includes: second buffer unit 201 for extracting audio coded data from an audio packet, which is an RTP packet, and for storing the extracted audio coded data into a buffer, and also for detecting packet loss; distance calculating unit 102 for calculating the distance between a location in the buffer where the packet loss is detected and a location where a next audio coded data is stored; gain calculating unit 202 for calculating the gain value (sound volume) of the next stored audio coded data in the buffer; second controlling unit 203 for determining a gain value of audio data for concealed audio that is generated in audio error concealment based on the distance calculated by distance calculating unit 102 and the gain value calculated by gain calculating unit 202; and decoding unit 104 for decoding the audio coded data when no packet loss has been detected and performing audio error concealment based on the gain value of the audio data for the concealed audio that is determined by second controlling unit 203 when packet loss is detected in second buffer unit 201.

In the exemplary embodiment, each of the abovementioned components specifically performs the operation below. The units different from those in the first exemplary embodiment will be mainly described.

When second buffer unit 201 receives an instruction to acquire the packet loss occurrence information from second controlling unit 203, it outputs the next stored audio coded data after seeing the location of the buffer head as well as the distance information described in the first exemplary embodiment and the packet loss occurrence information described in the first exemplary embodiment to second controlling unit 203.

Gain calculating unit 202 performs processing of either (A) or (B) below.
(A) Decoding the audio coded data that is input from second controlling unit 203 and generating the audio data. Then, calculating a first gain value, which is the gain value of the audio data, and outputting a first gain value information, which indicates the calculated result, to second controlling unit 204.
(B) Acquiring the first gain value, which is the gain value of the audio data, by extracting the gain value coding information from the audio coded data that is input from second controlling unit 203 and decoding the extracted gain value coding information. Then, outputting the first gain value information, which indicates the first gain value, to second controlling unit 203.

In the case of (A), some audio coding methods store past decoding information. If such methods are used, reset the past decoding information must be reset every time when gain calculating unit 202 decodes information in order to prevent the decoding from influenced by audio discontinuity.

Also in the case of (A), the method for calculating the first gain value is not specifically limited.

In the case of (B), it is assumed that the gain value coding information is embedded in the audio coded data at the audio packet transmitter.

Second controlling unit 203 outputs an instruction to acquire the packet loss occurrence information to second buffer unit 201 on a predetermined cycle.

After second controlling unit 203 has acquired the packet loss occurrence information, the distance information, and the next stored audio coded data from second buffer unit 201, it outputs the next stored audio coded data to gain calculating unit 202 and acquires the first gain value information from gain calculating unit 202.

When second controlling unit 203 acquires the packet loss occurrence information indicating that packet loss has been detected and acquires the distance information from second buffer unit 201, it determines a second gain value, which is the gain value of the audio data for the concealed audio that is generated in the audio error concealment, based on the distance information, and outputs the second gain value information indicating the determined result and an instruction to decode to decoding unit 104.

Here, the second gain value information is assumed to be in the range, for example, from 0 to 1. If the value is 1, it indicates that the audio coded data is to be decoded so that the gain value becomes equivalent to the audio data which is acquired at the previous decoding by decoding unit 104. If the value is 0, it indicates that the audio coded data is to be decoded with a predetermined gain value. If the value is a mean value between 0 and 1, it indicates that the audio coded data is to be decoded so that the gain value becomes that of the audio data, which is acquired at the previous decoding, multiplied with the mean value.

When second controlling unit 203 acquires the packet loss occurrence information indicating that packet loss has been detected and the distance information from second buffer unit 201, it sets the second gain value closer to 1 since the distance between the location of the buffer head and the location of the next stored audio coded data is shorter, and it sets the second gain value closer to 0 since the distance is longer based on the distance information.

Further, second controlling unit 203 sets the second gain value much closer to 1 if the presence of audio is predominantly recognized in the next stored audio coded data, and leaves the second gain value as the value set based on the distance information if no the presence of audio is recognized in the next stored audio coded data, according to the first gain value information.

The abovementioned second gain value information is merely an example. For example, the gain value information may be represented by its rate of change against the gain value set to decoding unit 104 in advance or the gain value information may be represented by a value equivalent to the rate of change, without any limitation. There is no limitation as to how much the distance information and how much the first gain value information each contribute to the second gain value information.

As mentioned above, the exemplary embodiment has an advantage in that it can further alleviate degradation of audio quality to human ears since it adjusts the gain value in the audio error concealment by taking account of the gain value of the next audio coded data stored in the buffer as well as the distance information described in the first exemplary embodiment.

### Third Exemplary Embodiment

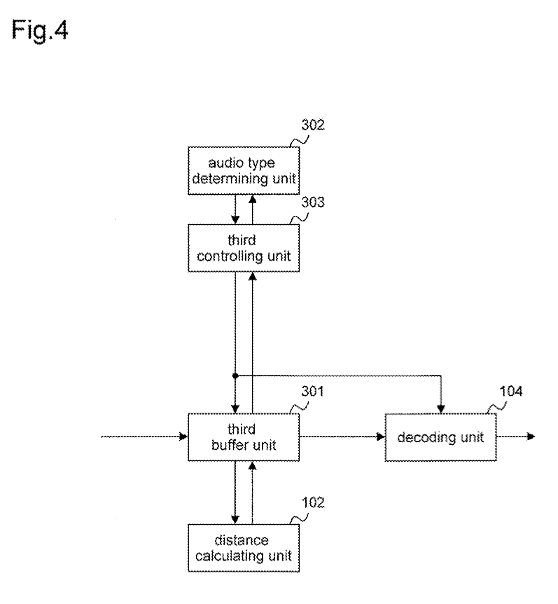

As shown in FIG. 4, the audio packet receiver of the exemplary embodiment includes: third buffer unit 301 for extracting audio coded data from an audio packet, which is an RTP packet, and for storing the extracted audio coded data into a buffer, and also for detecting packet loss; distance calculating unit 102 for calculating the distance between a location in the buffer where the packet loss is detected and a location where the next audio coded data is stored; audio type determining unit 302 for determining the audio type of the next stored audio coded data in the buffer; third controlling unit 303 for determining a gain value (sound volume) of audio data for concealed audio that is generated in audio error concealment based on the distance calculated by distance calculating unit 102 and the audio type determined by audio type determining unit 302; and decoding unit 104 for decoding the audio coded data when no packet loss has been detected and for performing audio error concealment based on the gain value of the audio data for the concealed audio that is determined by third controlling unit 303 when packet loss is detected in third buffer unit 301.

In the exemplary embodiment, each of the abovementioned components specifically performs the operation below. The units different from those in the first exemplary embodiment will be mainly described.

When third buffer unit 301 receives an instruction to acquire the packet loss occurrence information from third controlling unit 303, it outputs the next stored audio coded data after seeing the location of the buffer head as well as the distance information described in the first exemplary embodiment and the packet loss occurrence information described in the first exemplary embodiment to third controlling unit 303.

Audio type determining unit 302 performs processing of either (C) or (D) below.
(C) Acquiring bit rate information on the audio coded data from frame information in the audio coded data that is input from third controlling unit 303. Then, based on the bit rate information, determining whether the audio coded data corresponds to audio, mute, or noise, and outputting audio type information that indicates the determined result to third controlling unit 303.
(D) Based on a data length of the audio coded data that is input from third controlling unit 303, determining whether the audio coded data corresponds to audio, mute, or noise, and outputting the audio type information that indicates the determined result to third controlling unit 303.

In the case of (A), it is assumed that the audio data is coded with a plurality of compression rates at the audio packet transmitter, that the bit rate information is the information corresponding to either audio or mute or noise, and that the bit rate information is embedded in the audio coded data at the audio packet transmitter. For example, in such audio coding methods as AMR, G. 723.1, G. 729, information corresponding to the bit rate is transmitted as a part of the audio coded data.

In the case of (B), it is assumed that the data length is information corresponding to either audio or mute or noise.

Third controlling unit 303 outputs an instruction to acquire the packet loss occurrence information to third buffer unit 301 on a predetermined cycle.

After third controlling unit 303 has acquired the packet loss occurrence information, the distance information, and the next stored audio coded data from third buffer unit 301, it outputs the next stored audio coded data to audio type determining unit 302 and acquires the audio type information from audio type determining unit 302.

When third controlling unit 303 acquires the packet loss occurrence information indicating that packet loss has been detected and acquires the distance information from third buffer unit 301, it determines a gain value of the audio data for the concealed audio that is generated in the audio error concealment based on the distance information and outputs the gain value information indicating the determined result and an instruction to decode to decoding unit 104.

Here, the gain value information is assumed to be in the range, for example, from 0 to 1. If the value is 1, it indicates that the audio coded data is to be decoded so that the gain value becomes equivalent to the audio data which is acquired at the previous decoding by decoding unit 104. If the value is 0, it indicates that the audio coded data is to be decoded with a predetermined gain value. If the value is a mean value between 0 and 1, it indicates that the audio coded data is to be decoded so that the gain value becomes that of the audio data, which is acquired at the previous decoding, multiplied with the mean value.

When third controlling unit 303 acquires the packet loss occurrence information indicating that packet loss has been detected and acquires the distance information from third buffer unit 301, it sets the gain value closer to 1 since the distance between the location of the buffer head and the location of the next stored audio coded data is shorter, and it sets the gain value closer to 0 since the distance is longer based on the distance information.

Further, third controlling unit 303 performs any one of processing from (E) to (G) below based on the audio type information.
(E) If the audio type information corresponds to audio, setting the gain value much closer to 1.
(F) if the audio type information corresponds to mute, leaving the gain value as that set according to the distance information.
(G) If the audio type information corresponds to noise, setting the gain value to (E), (F) or any value between (E) and (F).

The abovementioned gain value information is merely an example. For example, the gain value information may be represented by its rate of change against the gain value set to decoding unit 104 in advance or the gain value information may be represented by a value equivalent to the rate of change, without any limitation. There is no limitation as to how much the distance information and how much the audio type information each contribute to the gain value information.

As mentioned above, the exemplary embodiment has an advantage in that it can further alleviate degradation of audio quality to human ears as it adjusts the gain value in the audio error concealment by taking account of the audio type of the next audio coded data stored in the buffer as well as the distance information described in the first exemplary embodiment.

Although the present invention has been described with reference to the exemplary embodiments, it is not limited to them. Various modifications to the configurations and details of the present invention can be made without departing from the scope of the present invention and can be understood by those skilled in the art.

For example, the audio packet receiver of the present invention can be mounted to a terminal device, or mounted to a gateway device as a receiving unit where the gateway device is placed between terminal devices for converting the audio coding method therebetween.

Instead of being implemented by a dedicated hardware device as mentioned above, the audio packet receiver of the present invention may be a device that records a program for implementing the functions of the audio packet receiver on a computer readable recording medium and that causes a computer to read and execute the program recorded on the recording medium. The computer readable recording medium includes recording media such as a floppy disk, a magneto-optical disk, and a CD-ROM, and storage media such as a hard disk device that is integrated into a computer. The computer readable recording medium also includes a device that dynamically saves a program for a short time in such a case where a program is transmitted over the Internet (a transmission medium or a carrier wave), and that saves a program for a certain period such as in volatile memory inside a computer which is used as a server in that case.

This application claims priority based on Japanese Patent Application No. 2007-179450 filed Jul. 9, 2007, and the disclosed patent application is hereby incorporated by reference in its entirety into the present patent application.

1. An audio packet receiver that performs audio error concealment for generating audio data for concealed audio when packet loss is detected, characterized by comprising:
a buffer unit that extracts audio coded data from an audio packet and stores the extracted audio coded data into a buffer, and that also detects the packet loss;
a distance calculating unit that calculates a distance between a location in said buffer where the packet loss is detected and a location where a next audio coded data is stored;
a controlling unit that determines a gain value of the audio data for the concealed audio based on the distance calculated at said distance calculating unit; and
a decoding unit that performs the audio error concealment based on the gain value of the audio data for the concealed audio that is determined by said controlling unit.

2. The audio packet receiver according to claim 1, further comprising:
a gain calculating unit that calculates the gain value of said next audio coded data,
wherein said controlling unit determines the gain value of the audio data for the concealed audio based on the distance calculated by said distance calculating unit and the gain value calculated by said gain calculating unit.

3. The audio packet receiver according to claim 1, further comprising:
an audio type determining unit that determines to which among audio, mute, or noise does said next audio coded data correspond based on a bit rate or a data length of said next audio coded data,
wherein said controlling unit determines the gain value of the audio data for the concealed audio based on the distance calculated by said distance calculating unit and the audio type determined by said audio type determining unit.

4. The audio packet receiver according to claim 1, wherein
the audio packet is an RTP packet, and
wherein said distance calculating unit calculates said distance based on an RTP time stamp value or an RTP sequence number in an RTP header of the audio packet.

5. An audio packet receiving method performed by an audio packet receiver that performs audio error concealment for generating audio data for concealed audio when packet loss is detected, characterized by comprising:
detecting packet loss by extracting audio coded data from an audio packet and storing the extracted audio coded data into a buffer, and then detecting the packet loss;
calculating a distance between a location in said buffer where the packet loss is detected and a location where a next audio coded data is stored;
determining a gain value of the audio data for the concealed audio based on said calculated distance; and
performing the audio error concealment based on said determined gain value of the audio data for the concealed audio.

6. The audio packet receiving method according to claim 5, further comprising:
calculating the gain value of said next audio coded data,
wherein said determining a gain value involves determining the gain value of the audio data for the concealed audio based on said calculated distance and said calculated gain value.

7. The audio packet receiving method according to claim 5, further comprising:
determining to which among audio, mute, or noise does said next audio coded data correspond based on a bit rate or a data length of said next audio coded data,
wherein said determining a gain value involves determining the gain value of the audio data for the concealed audio based on said calculated distance and said determined audio type.

8. The audio packet receiving method according to claim 5, wherein
the audio packet is an RTP packet, and
wherein said calculating a distance involves calculating said distance based on an RTP time stamp value or an RTP sequence number in an RTP header of the audio packet.

9-12. (canceled)
